(19) United States
(12) Patent Application Publication
(10) Pub. No.: US 2016/0013646 A1
(43) Pub. Date: Jan. 14, 2016

(54) LOAD MANAGEMENT, METERING, AND DEMAND RESPONSE MODULE

(71) Applicant: Heart Transverter, S.A., Heredia (CR)

(72) Inventor: Steve Heart Akerson, Puntarenas (CR)

(21) Appl. No.: 14/331,211

(22) Filed: Jul. 14, 2014

(51) Int. Cl. H02J 3/14; H02J 13/00

(52) U.S. Cl. CPC H02J 3/14; H02J 13/0006

(57) ABSTRACT

A system includes a plurality of switches. The plurality of switches includes a first switch connecting a first load in a plurality of loads to a power supply line. The power supply line is connected to a public utility power grid. The plurality of switches also includes a second switch connecting a second load in the plurality of loads to the power supply line. The system further includes a power measurement device configured to measure a power grid frequency at the power supply line. The system additionally includes a load control module configured to operate the second switch to disconnect the second load from the power supply line when the power grid frequency is lower than a predetermined frequency threshold.

### BACKGROUND

1. Field of the Invention

The present disclosure relates generally to the field of demand response. More specifically, the present disclosure is directed towards a load management, metering, and demand response module.

2. Description of Related Art

A known power conversion module is described in U.S. Pat. No. 6,344,985 B1, the disclosure of which is incorporated herein by reference in its entirety. The power conversion module is configured to convert DC power to AC power and efficiently transfer power between a variety of power producers and consumers. The power conversion module includes a plurality of bi-directional DC-DC converters, each connected to a voltage medium capacitor. The voltage medium capacitor is connected to another bi-directional DC-DC conversion device that is an inverter circuit with a voltage high side measured by a voltage high capacitor. The bi-directional DC-DC conversion device is configured such that a turns ratio between the voltage high side and another side of the DC-DC conversion device is the same as the ratio between conversion voltages. The voltage high capacitor is connected to a bi-directional AC-DC conversion device that is connected to a plurality of AC ports. Thus, the power conversion module is configured to transfer power between a plurality of DC ports and the plurality of AC ports in either direction while also decreasing transformer leakage inductance. The power conversion module may be used to connect distributed energy sources to local and/or remote power consumers.

Distributed energy sources such as photovoltaic cells and wind turbines installed at the limits of the power grid are becoming increasingly popular. The economics of installation and maintenance of such renewable energy sources has also improved dramatically in recent years. For example, homeowners may now affordably install and maintain a renewable energy unit at a reasonable cost. The energy unit may further be connected to a power grid using a power conversion module such as a grid-tie inverter to supply excess energy to the grid. In some cases, renewable energy sources may merely supplement and/or satisfy energy usage demands of a household. However, energy grid infrastructure in certain locations has advanced to allow energy consumers to supply excess energy produced from renewable local energy production systems to other energy consumers. Thus, energy consumers may have the opportunity to become net energy producers. In some cases, the owners of these power generators may be reimbursed for the energy they supply to the grid, which may in turn increase the financial return on the investment and affordability of installing such units.

However, with the emergence and increased availability of these sources and their corresponding integration into public power grids, the stability of power grids may be compromised. For example, most renewable energy sources such as solar panels and wind turbines have a limited power generation capacity. The peak power generation period for a photovoltaic panel may be in the afternoon, while no power generation may occur during evening hours. Cloud cover may further affect the power supplied to the grid. Thus, the power supplied to the power grid from such sources may be highly variable, which in turn affects the stability of the power grid itself.

Stability in the power grid is critical. For example, de-stabilization in the line voltage of the power grid may lead to service interruptions including brownouts of large areas with critical power requirements. One way to manage stabilization of the power grid includes using peaker plants to supply power to the grid during peak usage periods. However, the start-up and/or lead time required by such facilities may be too extensive to react to the near-instantaneous changes in the power grid. Further, peaker plant operation may be expensive and inefficient. As another example, control mechanisms may be established in a central location for measuring and reacting to power grid fluctuations. However, inherent physical latency in electronic communication networks and control mechanisms may make it difficult and/or impossible to react to power grid fluctuations from a central location before de-stabilization of the power grid occurs. Still further, power grid operators may lack adequate controls for regulating the power contributions of these disparate power producers.

### SUMMARY

According to one embodiment of the disclosure, a load management system includes a plurality of switches. The plurality of switches includes a first switch connecting a first load in a plurality of loads to a power supply line. The power supply line is connected to a public utility power grid. The plurality of switches also includes a second switch connecting a second load in the plurality of loads to the power supply line. The system further includes a power measurement device configured to measure a power grid frequency at the power supply line. The system additionally includes a load control module configured to operate the second switch to disconnect the second load from the power supply line when the power grid frequency is lower than a predetermined frequency threshold.

According to another embodiment of the disclosure, a load management method includes connecting a first load in a plurality of loads to a power supply line connected to a public utility power grid using a first switch in a plurality of switches. A second load in the plurality of loads is connected to the power supply line using a second switch in the plurality of switches. A power grid frequency is measured at the power supply line for determining that the power grid frequency is lower than a predetermined frequency threshold. In response to determining that the power grid frequency is lower than a predetermined frequency threshold, the second switch is operated to disconnect the second load from the power supply line

Other features and advantages will be apparent to persons of ordinary skill in the art in view of the following detailed description of the present disclosure and the accompanying drawings.

### BRIEF DESCRIPTION OF THE DRAWINGS

For a more complete understanding of the present disclosure, needs satisfied thereby, and features and advantages thereof, reference now is made to the following descriptions taken in connection with the accompanying drawings in which:

FIG. 1 illustrates a high level block diagram of a load management, metering, and demand response module integrated in a local power system in accordance with a non-limiting embodiment of the present disclosure.

FIG. 2 illustrates a load management, metering, and demand response module in accordance with a non-limiting embodiment of the present disclosure.

FIG. 3 illustrates internal components of a load management, metering, and demand response module in accordance with a non-limiting embodiment of the present disclosure.

FIG. 4 illustrates pump performance data showing pump flow rate against the number of stages and/or horsepower for a particular water pump shown in accordance with a non-limiting embodiment of the present disclosure.

FIG. 5 illustrates the real power supplied to the pump against the pressure in the pump for a particular water pump shown in accordance with a non-limiting embodiment of the present disclosure.

FIG. 6 illustrates a flow chart of a method for load management, metering, and demand response in accordance with a non-limiting embodiment of the present disclosure.

FIG. 7 illustrates a flow chart of a method for load management, metering, and demand response in accordance with a non-limiting embodiment of the present disclosure.

FIG. 8 illustrates a flow chart of a method for load management, metering, and demand response in accordance with a non-limiting embodiment of the present disclosure.

### DETAILED DESCRIPTION

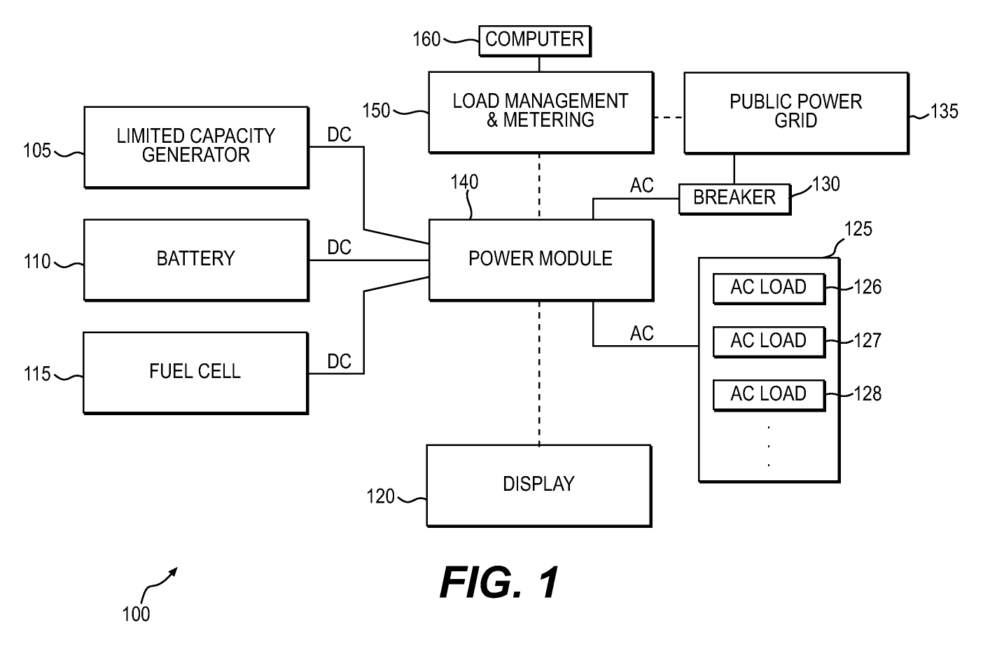

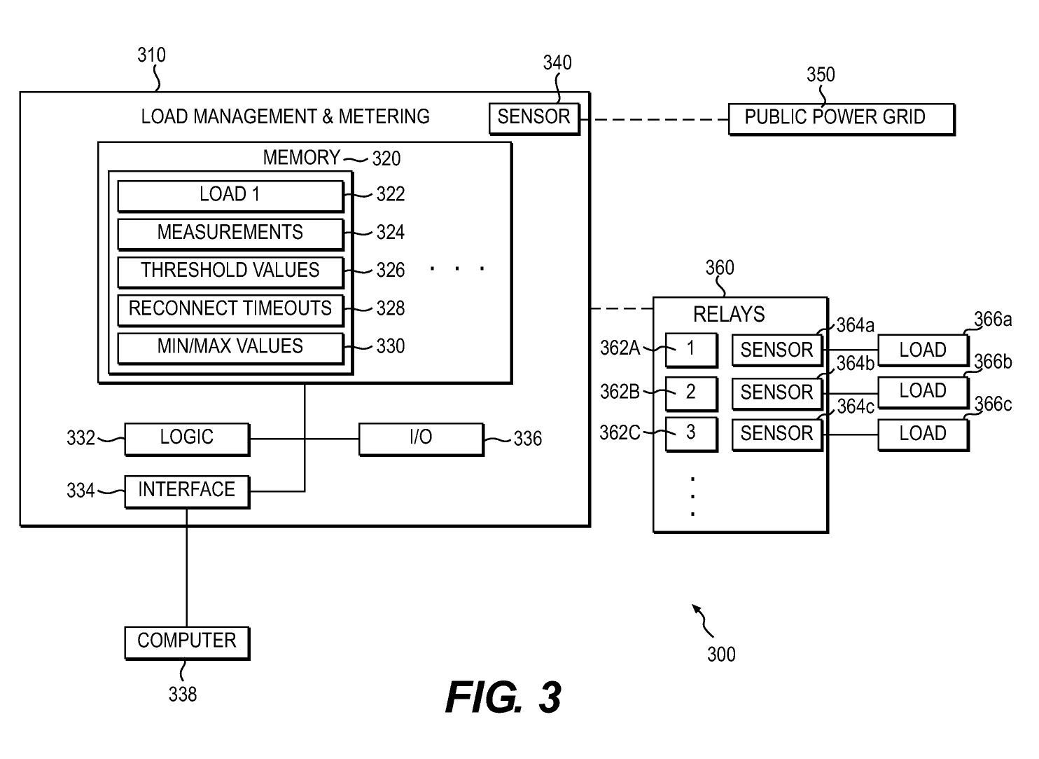

Embodiments of the present disclosure and their features and advantages may be understood by referring to FIGS. 1-8, in which like numerals are used for like corresponding parts in the various figures.

In certain embodiments, the teachings of the present disclosure may improve the monitoring and control of loads in an electrical power system using a load management and advanced metering device. The load management and advanced metering device may include logic controlled relays for regulating loads. The current of each relay may be measured with a waveform analysis, which may be used for substantially real-time control of the relays. The measurements may be communicated for integration with an advanced metering infrastructure. The systems and methods presented in the present disclosure may provide solutions to smart-grid inefficiencies and problems when implemented at scale. Thus, the teachings of the present disclosure may improve the stability, monitoring, and control of a public utility grid.

In certain embodiments, a local power sub-system, such as a micro-grid for a home or office, includes one or more power modules connected to various loads drawing electrical power from one or more of a power utility grid and/or a limited capacity generator, such as a solar panel or wind turbine power source. The power module may include a bi-directional power inverter that may be used to convert DC power to AC power. Power inverters may transfer power between a variety of power producers and consumers. For example, a power inverter may transfer and convert power from various DC sources to various AC consumers. As another example, a grid-tie inverter may be used to transfer power between a solar array, batteries, local loads, and/or a public utility grid. The power module may generally control critical loads of a power system, and may be used to reduce system reliance on consuming power form a utility power grid. The power module may further supply excess power generated by a local limited capacity generator that is not being used by connected loads to the public utility grid. However, other non-critical loads of the local micro-grid may be connected directly to the public utility grid.

Distributed energy sources such as photovoltaic cells and wind turbines installed at the limits of the power grid are becoming increasingly popular. The economics of installation and maintenance of such renewable energy sources has also improved dramatically in recent years. For example, homeowners may now affordably install and maintain a renewable energy unit at a reasonable cost. The energy unit may further be connected to a power grid to supply excess energy to the grid. In some cases, renewable energy sources may merely supplement and/or satisfy energy usage demands of a household. However, energy grid infrastructure in certain locations has advanced to allow energy consumers to supply excess energy produced from renewable local energy production systems to other energy consumers. Thus, energy consumers may have the opportunity to become net energy producers. In some cases, the owners of these power generators may be reimbursed for the energy they supply to the grid, which may in turn increase the financial return on the investment and affordability of installing such units.

However, with the emergence and increased availability of these sources and their corresponding integration into public power grids, the stability of power grids may be compromised. For example, most renewable energy sources such as solar panels and wind turbines have a limited power generation capacity. The peak power generation period for a photovoltaic panel may be in the afternoon, while no power generation may occur during evening hours. Cloud cover may further affect the power supplied to the grid. Thus, the power supplied to the power grid from such sources may be highly variable.

In certain embodiments, the load management and advanced metering device of the present disclosure may analyze local conditions of a micro-grid and stabilize the larger utility grid based on this analysis. In certain embodiments, the load management and advanced metering device of the present disclosure may analyze the conditions of any limited capacity generator and stabilize its operation by opening and closing relays based on predetermined conditions. Stabilizing limited capacity generators may be essential for micro-grid reliability and consistency.

In certain embodiments, the load management and advanced metering device of the present disclosure may enable significant energy savings by reducing non-critical load usage. Further, usage may be reduced in a manner that increases the stability of both the micro-grid and the public utility grid. Demand response programs may be initiated that may pay participants for participation in an energy demand response scheme. Thus, revenue to energy suppliers on the grid may be increased by adapting load utilization to stabilize grid frequency.

In certain embodiments, the load management and advanced metering device may control inductive motor loads. The inductive motor loads may be analyzed to provide detailed information to determine physical parameters connected to a pump. For example, pressures, flow rate, water levels, and other parameters may be measured and controlled using the load management and advanced metering device.

In certain embodiments, a load management and advanced metering device includes a digital to analog converter that measures currents passing through a series of relays connected to one or more non-critical loads. The digital to analog converter may additionally measure the current passing through the lines for the total service to the utility grid. Further, the voltage of the lines for the total service to the utility grid may also be measured. Based on these high speed measurements, root mean squared (“RMS”) readings may be updated for every wave shape. For example, the readings may be updated every 17 ms for a 60 Hz wave. In certain embodiments, true power, volt amps, reactive power, and/or power factor may be obtained for each wave shape. In certain embodiments, the load management and advanced metering device accommodates interface links to communicate the measured values at high speeds for display and analysis. For example, the measurement values may be conveyed and displayed via a computer using an oscilloscope-like display interface. Wave shape values may also be communicated to the computer.

In certain embodiments, a load management and advanced metering device determines minimum and maximum values for respective properties for each relay. For example, registers or other memory devices may store minimum and maximum measured values for one or more of voltage, power, current and/or frequency measurements for each relay. Logic may be applied to open and close individual relays based on the measured values as compared to the stored settings for each relay. The logic may be programmed to open and close relays based on user specified settings. Thus, programmable logic may control opening and closing individual relays.

Variable relay threshold release values may be important in grid stabilization. For example, a series of load management and advanced metering devices connected to a central power grid may be programmed to distribute the release of key loads at distributed frequency ranges. If a first frequency threshold is reached by the central power grid, a first load may be removed. If each load management and advanced metering device on the grid were set to release a respective load at the first frequency threshold, the grid frequency may overcorrect, and become too low. However, distributed and variable relay threshold release values may ensure a stable response as grid frequency reaches unstable frequencies, while reducing occurrences of overcorrection by removing too many loads at once.

With reference to FIG. 1, a load management and advanced metering device 150 is integrated into a local power system 100. Power module 140 receives DC power from one or more of limited capacity generator 105, battery 110, and/or fuel cell 115. In certain embodiments, power module 140 may connect limited capacity generator 105 to battery 110 and/or fuel cell 115 to charge those modules. In certain embodiments, power module 140 converts DC power from limited capacity generator 105, battery 110, and fuel cell 115 into AC power and transfers the power to AC Loads 126-128. In certain embodiments, power module converts AC power from public power grid 135 to DC power to charge one or more of battery 110 and/or fuel cell 115. When battery 110 and fuel cell 115 is low and generator 105 is not producing any energy, power module 140 may transmit power from breaker 130 to AC Loads 126-128. Load management and metering device 150 may be programmed to control power transmission to each AC Load 126-128 for more efficient power management by using installed relays between power module 140 and each AC Load 126-128. The relays may be switches that may disconnect each AC Load 126-128 when operated by the load management and advanced metering module. The load management and advanced metering module may contain logic for operating the relays. Thus, public power grid stability is maximized and usage is minimized. Additionally, internal system stability and efficiency is maximized.

Load management and advanced metering device 150 may be connected via an interface to a computer 160, which may display oscilloscope-like wave-shape readouts from each measurement device connected to load management and metering device. For example, each relay may be connected to and/or contain a measurement device for measuring one or more of current, voltage, real power, power factor, and frequency of the load line. The relay may transmit this information to load management and metering device 150. Similarly, a measurement device may be connected to the public power grid 135 main line. The measurement device may measure one or more of current, voltage, real power, power factor, and frequency of the main line. The measurement device may transmit this information to load management and metering device 150. Computer 160 may program load management and metering device 150 to take certain actions based on the detected measurements.

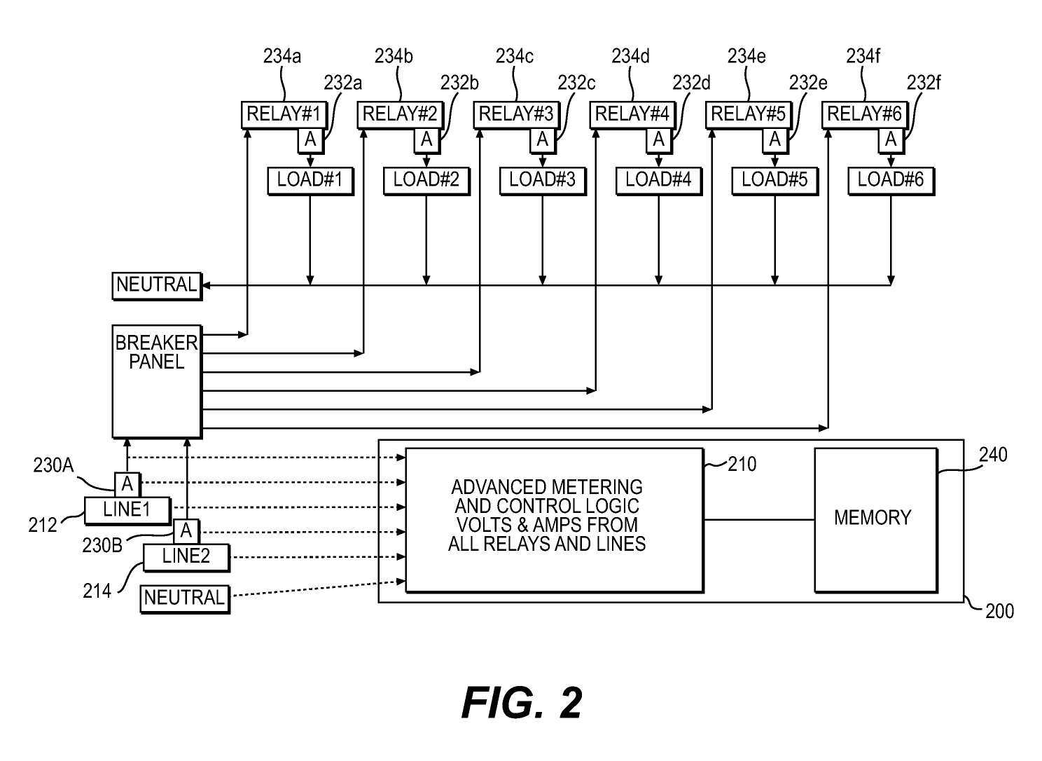

Referring to FIG. 2, a load management and advanced metering device 200 is illustrated in accordance with a particular non-limiting embodiment of the present disclosure. Load management and advanced metering device 200 includes advanced metering and control logic 210. Advanced metering and control logic 210 connects to current transformers for utility grid service from lines 212 and 214. Advanced metering and control logic 210 also connects to the voltage of lines 212 and 214. Current sensors 230A-B and 232A-F measure current running through each line 212-214 and each relay 234A-F. Voltage across each relay 234A-F may also be measured. Line frequency may be determined by measuring the wavelengths generated by these measurements. Load management and advanced metering device 200 also includes memory 240 that may store some and/or all of the measured values. Memory 240 may further store maximum and minimum set values for each component property. For example, memory 240 may store maximum and minimum set values for relay 234A voltage. Example properties for which measurements, minimum value and maximum values may be stored for include one or more of voltage, current, power, and/or frequency.

In certain embodiments, advanced metering and control logic 210 may restore loads with a graduated response. For example, each relay 234A-F may be set to cut out at a different frequency. This frequency may be programmatically adjustable. Advanced metering and control logic 210 may provide this functionality. Frequency threshold values may be stored in memory 240. For example, advanced metering and control logic 210 may cut out relay 234A at a predetermined frequency based on a frequency stored in memory 240. In certain embodiments, the frequency threshold may be adjustable between a certain range. For example, the frequency threshold may be adjustable from 57.8 Hz to 60.6 Hz in 0.2 Hz increments. Each relay may reconnect when the frequency detected in lines 212 and/or 214 reaches, exceeds, or falls below a reconnect frequency. Similarly, advanced metering and control logic 210 may connect a load when the frequency detected in Lines 212 and/or 214 reaches and/or exceeds another predetermined frequency. As another example, advanced metering and control logic 210 may cut out relay 234A when a predetermined voltage range is detected in lines 212 and/or 214. Other properties of line power may further be used to augment connection of loads to respond in near real time to line power observations.

Certain loads may be prioritized by removing lower priority loads from the system. For example, relay 234A may be connected to a high priority load 236A, while relay 234B may be connected to a low priority load 236B. Advanced metering and control logic 210 may be programmed to prioritize load 236A over load 236B. Thus, when a release frequency threshold is reached, advanced metering and control logic 210 may respond by tripping relay 234B to disconnect low priority load 236B. If the frequency stabilizes, removal of load 236A may be avoided. However, even high priority loads may be disconnected if line frequency stabilization is not achieved. For example, when a release frequency threshold is reached, advanced metering and control logic 210 may respond by tripping relay 234B to disconnect low priority load 236B. If the line frequency does not stabilize, a second release frequency threshold may be measured in the line. Once this second release frequency threshold is reached, advanced metering and control logic 210 may respond by tripping relay 234A to remove load 236A. Advanced metering and control logic 210 may continue to trip relays 234A-F in order of priority for each release frequency threshold that is reached in the line. This cascading effect may stabilize line frequency before a majority of higher priority loads are removed. For example, each node in the utility power grid may have low priority loads removed first. In the aggregate, this may stabilize the line frequency before a substantial number of higher priority loads are removed.

The frequency release thresholds may be set, monitored, and/or adjusted. For example, each frequency release threshold may be adjustable in 0.2 Hz increments. Thus, higher priority loads may be set to be removed at the upper limits of grid frequency stability. Thus, higher priority loads may only be removed when substantial threats to grid stability are detected.

In certain embodiments, each relay may have a corresponding reconnect delay that may be set to a predetermined time period. The available time periods may range, for example, between six seconds and six minutes. The reconnect delay may cause advanced metering and control logic 210 to wait a predetermined amount of time before reconnecting a particular load. A time periods may be specified for each relay/load combination. Certain electrical devices, either due to design considerations or natural physical device characteristics, may more efficiently handle frequent shutoffs. For example, a heating element may work better with a shorter reconnect delay while compressors, such as refrigerators or air conditioners may require more time between power cycles. Compressors may require pressure dissipation in order to be more easily started. Thus, as the generator becomes overloaded and the frequency begins to drop, advanced metering and control logic 210 may remove the lowest priority relay, i.e., the relay with load prioritized to handle the highest dropout frequency, first. In this example, if removal of the lowest priority load reduces the load enough to stabilize the line frequency, then no further loads will be removed and the low priority load may be brought back online once the reconnect delay is reached. However, if the line frequency fails to stabilize after removal of the lowest priority load, advanced metering and control logic 210 will continue to disconnect relays in order of priority based on each corresponding dropout frequency. Thus, an automatic, smooth, frequency regulation system may be implemented that favors operating the highest priority loads as designated by the user.

In certain embodiments, each relay may, additionally or alternatively, have a corresponding reconnect frequency that governs the line frequency at which the relay/load combination may be brought back online. For example, when advanced metering and control logic 210 detects that line frequency has stabilized to reach a certain reconnect frequency, the corresponding load/relay combination may be brought back online. Reconnect delays and/or reconnect frequencies may be used exclusively or in combination with one another. Advanced metering and control logic 210 may determine when or if to use these or additional relay/load reconnection processes.

Any number or combination of relays and other components may be utilized in various embodiments of the present disclosure. For example, the embodiments describing six separate relays are merely didactic in nature and should not be construed as limiting the present disclosure to the configuration and/or number of relays disclosed herein.

A load management and advanced metering device may, additionally or alternatively, manage and/or meter energy sources. For example, a solar panel configuration may be connected to a DC-AC power inverter module to supply excess energy to a power grid. However, the energy contribution from the solar panel may contribute to the instability of the power grid. Accordingly, the teachings of the present disclosure may allow the programming, management and/or control of the energy contributions of disparate energy producers by a central grid operator, local grid operator, and/or other operator via a load management and advanced metering device.

Relays and/or measurement devices may be connected to energy producing units. The load management and advanced metering device may control the relays to disconnect the energy producing units when predetermined conditions are determined in one or more of the local and/or public utility power grid. In certain embodiments, a central grid operator may program one and/or many load management and advanced metering devices spread across a power grid to perform various grid stability functions.

A grid operator may determine that no new disparate energy producers should be connected to the power grid once certain conditions are detected in the grid. The grid operator may further determine that some and/or all disparate energy production units should be disconnected from the power grid once certain conditions are detected in the grid. The load management and advanced metering device may be programmed to disconnect any energy producing units that are connected to the power grid, such as any solar panel units or wind turbine units, when the power grid frequency reaches a predetermined threshold, such as, for example, 60.2 Hz. As another example, a load management and advanced metering device may be programmed to disconnect and/or stop connecting additional energy producing units when a local line voltage reaches a certain voltage, such as, for example, 128 VAC. These cutoff thresholds may further be staggered at various levels across different units. Thus, while the predetermined cutoff thresholds may be received from a central grid operator, the determination of when those conditions exist may be performed locally by a load management and advanced metering device. Accordingly, the latency problems generally experienced with central management of disparate energy producers may be avoided.

In one example configuration, loads include a hot water heater, an air conditioner, and a water pump. Relays are connected to each load and current sensors are configured at each relay. A logic unit contains instructions for management of each of the loads. The logic unit receives current, voltage, power factor, and frequency measurements from each relay. The logic unit is connected to a power grid line transmitting power to each load. The logic unit measures the voltage, current, power factor and frequency of the power grid line. Minimum and maximum values for each respective property of each load may be stored. A user configures the hot water heater to be the lowest priority load, the air conditioner to be the second lowest priority load, and the water pump as the highest priority load. A frequency release threshold corresponding to each relay/load combination is stored in a memory connected to the logic unit. The corresponding frequency release thresholds are staggered such that the power grid may experience a gradual and/or smooth response to each frequency release threshold. A reconnect delay may be set for each relay/load combination. Additionally or alternatively, a reconnect frequency may be set for each relay/load combination. Various other loads may be connected with corresponding relays and corresponding settings and the logic unit may store corresponding measurements for these other loads.

In this example, the logic unit detects a frequency in the power grid line at the first staggered frequency release threshold. This first staggered frequency release threshold corresponds to the lowest priority load, i.e., the water heater. The logic responds to detecting a frequency in the power grid line at the first staggered frequency release threshold by disconnecting the lowest priority load at the corresponding relay. Thus, the water heater is brought offline. The logic unit continues to monitor the power grid line frequency. The logic unit may start a timer that measures the amount of time that the water heater has been offline. Once the logic unit determines that the amount of time measured by the timer has reached a corresponding reconnect delay, the logic unit may reconnect the water heater. Additionally or alternatively, the logic unit may detect a frequency in the grid line that matches a reconnect frequency corresponding to the water heater. Once this reconnect frequency has been measured, the logic unit may either reconnect the water heater or may wait for the reconnect timeout to lapse before reconnecting the water heater.

In certain embodiments, a load management and advanced metering device may be designed to connect to multiple power modules. For example, the device may be designed to connect to 12 power modules that are two KW each. The power modules may be controlled and automatically regulated individually while accounting for any phase relationships that they require. In certain embodiments, it may be more efficient to configure loads across one or more power modules. For example, a typical home or business may have only two power modules handling a total of around four KW of power while having a grid connection of 24 KW for 100 amp service from a power grid. The load management and advanced metering device may be equipped to handle any combination of power modules totaling any amount of power, either for home, commercial, government, or public use. The emergence of the smart grid may encourage a migration from traditional power meters to smart digital power meters that may be capable of integration with smart load management and renewable energy infrastructures, which would also permit reducing the grid infrastructure and lowering the power service required for each endpoint, for example, to 50 amp service.

In certain embodiments, a load management and advanced metering device may have connections for line voltage sense inputs and outputs for relays. For example, one such device may have connections for four line voltage sense lines and six 30 amp relays. In certain embodiments, the load management and advanced metering device may have a Cat5 cable connection that may connect to a small connector module which may connect to current sensors. The current sensors may detect current for main grid input lines. For example, the current sensors may detect current for a typical 100 amp service via the grid input lines. In certain embodiments, a load management and advanced metering device may have RJ45 connectors. For example, the device may have a pair of RJ45 connectors, e.g., one labeled “UP” and one labeled “DOWN.” These connectors may allow the device to be connected at the end of a last power module. Such a configuration may allow continual communications with a power system information bus.

In certain embodiments, power for the internal electronics of a load management and advanced metering device may be received directly from a power module or directly from the AC grid lines. For example, the device may receive power from a 50 volt rail on the main power modules. As another example, the device may receive power from one or more of four AC grid lines that are active. In certain embodiments, no power modules are included in the system. In certain embodiments, input grid lines may be connected to split phase mains from the grid. In certain embodiments, three lines may be connected to three phase grid power lines. In certain embodiments, two lines may be connected to a second grid service, e.g., in 100 amp service configurations. In certain embodiments, two lines may be connected to the mains of a generator, for example, in a commercial uninterruptable power supply (“UPS”) system.

In certain embodiments, the voltage and current of each line is analyzed by a logic unit in substantially real time. For example, the voltage and current of each line may be measured to provide oscilloscope-like functionality. Additionally or alternatively, other properties of each line may be analyzed. For example, the power factor, true RMS voltage, current, and real power of each line may be analyzed and measured in near real time. In certain embodiments, all four lines may be analyzed by the logic unit. The logic unit may define a first line with acceptable voltage as phase 1. The logic unit may phase lock to the line voltage phase. Additionally or alternatively, other lines may be represented in relation to the phase 1 line, e.g., as phases 2-4. The logic unit may perform true graphical analysis of the phase relationships of each line's measured voltage and current. The frequency of phases 1 and 3 may be measured to an accuracy of 0.002 Hz.

In certain embodiments, six isolated relays may be connected to the various outputs on the breaker panel. Each isolated relay connects to various key loads that may need to be individually analyzed and controlled. Each relay may be connected to the actual individual loads. When the relay is in an open position, the voltage across the relay is analyzed to determine if a load is present. The voltage may also be analyzed to determine the phase of the load. The logic unit may direct the relay to close during normal load management operations. When the relay is in the closed position, the current through the relay may be measured and the logic unit may conduct a full oscilloscope analysis including power factor, RMS current, and/or real power measurements. If the current rises above a predetermined maximum limit, the logic unit may control the relay and the relay may automatically open. For example, if split phase 220 volt loads are used the relays may be used in pairs. As another example, for three phase loads, the relays may be used in sets of three. In certain embodiments, a pair of 30 amp relays may be used for a 220 volt load and may support approximately 6.6 KW.

In certain embodiments, a relay may provide current to a coil of a larger contactor (e.g., another relay). The larger contactor may be two or three phase. This configuration may allow one 30 amp relay to control about a 100 amp three phase contactor. In this example configuration, the relay current wave-shape sensor may only sense the current of the contactor coil. This measured current may be of little interest when measured in isolation. However, external clamp-on current sensors may be used to measure the overall current of the controlled load.

In certain embodiments, the relays may control and analyze DC circuits. For example, relays may be used to manage high voltage strings of solar panels. As another example, each relay may typically control and analyze six KW of high voltage solar panels. Such a configuration may allow integration of the teachings of the present disclosure with bidirectional DC-AC power inverters, grid tie systems, and/or grid tie inverter systems.

The embodiments discussed in accordance with the present disclosure may present load management capabilities. Large loads, such as air-conditioners, may be selectively turned off or cycled to manage peak load conditions on the grid. In certain embodiments, a load management and advanced metering device may have an interface. For example, a load management and advanced metering device may have a USB interface connection on one or more remote panels. The remote panels may be configured to communicate with the load management and advanced metering device. In certain embodiments, the interface may be available at the load management device. A computing device (e.g., a personal computer, tablet, smart phone, or the like) may connect to the interface. The computing device may communicate with computer systems on the power grid in real time and/or near real time to adjust load management configurations at the load management and advanced metering device.

In certain embodiments, loads may be programmatically shed based on the use or discharge of a battery. Consequently, battery run time may be greatly extended by selectively shedding lower priority loads as batteries are discharged. Remote panels may contain a real time and/or near real time clock that may automatically update via the interface connection. For example, a computer may connect to the interface connection and synchronize an internal scheduling clock in the load management device. Thus, in certain embodiments, automatic lighting, water pumping, refrigeration, and other loads may be managed using the teachings of the present disclosure. Further, these load management capabilities may enable other useful features. For example, lights may be automatically turned on while a family is away on vacation. As another example, air conditioning usage may be throttled down when a security system senses no motion in a house.

In certain embodiments, frequent voltage drops on a public utility power grid or other localized power micro-grid may cause damage to certain motors such as, for example, inductive motors. Inductive motors may be included in refrigerators, compressors, and pumps. The load management and advanced metering device may monitor the voltage of such grids. Thus, inductive motors and other loads that may be damaged by such voltage fluctuations may be disconnected when voltage dips are detected.

In certain embodiments, the load management and advanced metering device may be configured to delay for a predetermined time before re-connecting the inductive motor load, or other specified load, to the power grid. Such a delay may allow pressure to bleed of the compressor so stress on the motor is reduced. As another example, a home-use refrigerator may not be capable of starting until pressure has bled off the compressor. Current protection devices may ensure that the motor does not start until sufficient pressure run-off has occurred. However, these current protection devices may be put under significant stress by tried and failed attempts at starting the protected motor. For example, the system may go through three or four tries before the motor is successfully started. Thus, incorporating restart delays may decrease the stress put on such devices, motors, and/or compressors.

Voltage dips across a grid generally may indicate that the grid is overloaded. Thus, automatic load shedding features may impact the stability of a power grid. In certain embodiments, grid frequency dipping may be used to disconnect loads.

In certain embodiments, one or more generators may be connected to a power system and/or micro-grid. Loads controlled with relays as discussed in the present disclosure may delay reconnection until the generator has come up to speed and/or stabilized. Stabilization of a generator may include starting all other loads before connecting relays. The load management and advanced metering device may further stagger connection of the loads by controlling the relays so that the generator does not have to bear the burden of starting all of the loads at one time or at approximately the same time. Large relay controlled loads may often be inductive motors, such as air-conditioners, that may require large power surges to start-up. In certain configurations, if too many inductive motors are started at the same time, the power drawn by each load at start-up may bog down the generator, which may in turn compromise other currently running loads. Larger commercial UPS systems may have less critical loads. For example, a refrigerator may not be required to run for, as an example, an hour.

As an example, an office building may have 100 amp service from a public utility power grid with a 24 KVA backup generator. One relay may be connected to a 100 amp contactor for the grid and another relay may be connected to at 100 amp contactor for the generator, while another relay may be connected to the automatic start circuit for the backup generator. When the public utility power grid fails, the air-conditioner may not work, but everything else may be connected to the generator via a power module. Batteries may hold a charge from a limited capacity and/or renewable generator. Thus, loads may draw power form the batteries first when the grid fails via the connected power module. When enough time has transpired such that the batteries are running low, the automatic generator start relay may close, thus connecting the generator start relay to power supplied by the batteries. The generator may then start. After the generator has come up to speed and stabilized, the load management and advanced metering device may close the 100 amp contactors and the power module may start to integrate generator power into the system. After this integration has stabilized, the load management and advanced metering device may begin closing individual load relays, such as for the air-conditioner. The office building may thus begin to cool and the batteries may be charged. The battery charging may be automatically interrupted when the air-conditioner starts. When the building cools down, the air-conditioner thermostat may shut the air-conditioner off and the generator contactors may be disconnected, shutting of power to the generator. However, while the generator was running, it may have sufficiently charged the batteries such that the office building may now be running on generator energy stored in the batteries. The generator startup sequence as described above may be repeated automatically once energy is drained from the batteries. In certain embodiments, a user may intervene and control the power cycle described above. The phased generator operation may often cut generator run time drastically, while reducing generator fuel consumption. Further, these techniques may be employed during disaster related power outages in order to decrease fuel consumption costs of hospitals and other essential operations. Further, power inverters and/or power modules may insert any renewable power generator in place or in addition to a generator in the above described systems. Including a renewable generator may further reduce or eliminate generator run time. Thus, 24 hour power requirements during power grid failures may be met while running a generator for a short amount of time. Homes, recreational vehicles, and boats may also employ similar techniques. Smooth power integration of multiple generators and phased load introduction may reduce start-up impacts to the grid. Accordingly, grid and generator stability may be increased by the teachings of the present disclosure.

The load management and advanced metering device may have built-in oscilloscope functionality to examine and diagnose deceptive AC power characteristics. For example, inductive motors running on AC voltage may increase and/or decrease the current. Such an effect may give the impression that the power consumed is also increasing or decreasing. But inductive motors may be phase locked to the frequency of the grid. Thus, the physical work or output power of the motor may not change. While current may lag the voltage by some phase angle, this angle may be automatically adjusted so that the actual output power may be the same despite the shift in voltage and amps. Power factor may include real power divided by volt-amps (V×amps). Thus, the near real-time oscilloscope functionality of the load management and advanced metering device may allow consideration of wave-shapes and may effectively analyze and control AC power.

In certain embodiments, the load management and advanced metering device may be used with a water pump. For example, a submersible water pump includes a submersible pump, a pump starting box, three electrodes to sense water level in the well, an electronic water level sensor to connect to the electrodes, a contactor with current sensing to protect the pump, and a pressure switch if the pump is filling a pressure tank. Additionally or alternatively, a level sensor for a tank if the pump is filling an open tank may be included. There may also be a timing device used to schedule pump operations. The complexity and number of these components may increase the trouble of purchasing, installing, troubleshooting and maintenance of these systems.

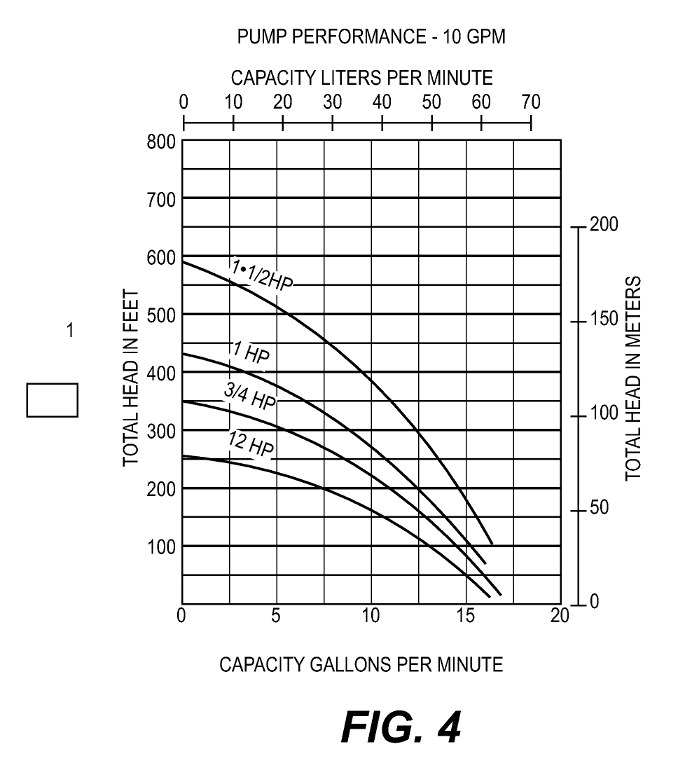

With reference to FIG. 4, certain pump manufacturers may supply pump performance data, such as the pump performance data in FIG. 4. The water system engineer may try to get a pump with the correct number of stages and/or horsepower. The number of stages and/or horsepower may provide the requisite flow rates for the pressure range that is needed. Operating pressure for a pressure tank may fluctuate about an operating point. The operating pressure may fluctuate around this point with a difference between cut-in pressure and cut-off pressure of about 20 psi. Thus, as the level of water in the well fluctuates, the operating point may change. However, the operating range of 20 psi may remain the same for the pump system.

In certain embodiments, the load management and advanced metering device may monitor real consumed power throughout the wave-shape. Thus, actual power consumed by the pump may be measured with high-accuracy. This may allow deduction of operating information for the pump.

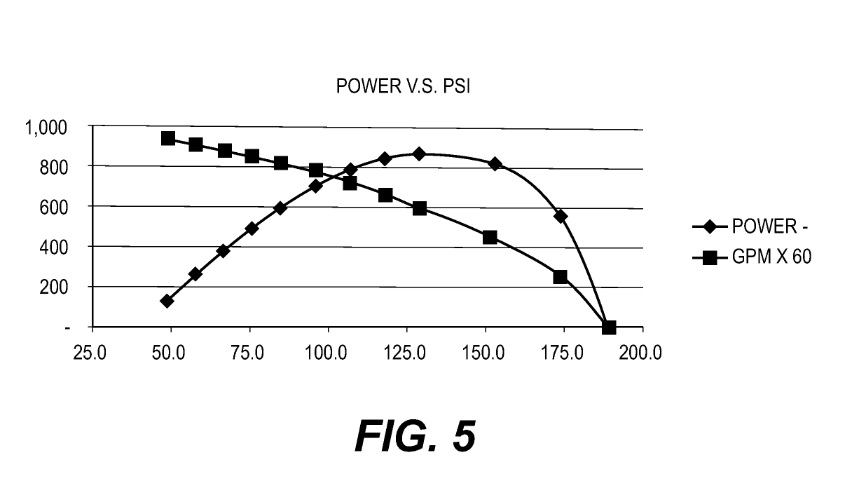

With reference to FIG. 5, real electrical power in watts supplied to an example pump is plotted against real pressure in the pump. Actual gallons per minute that may be delivered at the measured pressure for the given pump configuration is shown in FIG. 5. However, it may be costly and inefficient to set up sensors to measure this information for each complex pump installation. Thus, the teachings of the present disclosure may provide several methods for deducing this data without application of actual data sensors, via measurement of power usage characteristics of the pump.

In certain embodiments, logic within the load management and advanced metering device may determine the water pressure in the pump system from the power used by the pump, as well as additional pump operation information. However, this reading would only provide the total pressure from the water level in the well to the pressure in the tank. Since the water level in the well may change merely based on the seasons, rainfall, weather, and drawdown, measuring the pressure in the tank may be unreliable. In certain embodiments, a normal pressure switch may be connected between several lines of the system in order to notify the load management and advanced metering device of the pressure of the switch. When pressure in the tank drops to 30 psi, the pressure switch turns on and, depending on what set of rules may be applied to the energy system, a pump may be turned on. In FIG. 5, maximum pump pressure is achieved at about 130 psi. Thus, as the pump runs for a short time, the power either increases or decreases, but only by a slight margin. Measuring this can be used to determine which of the two points on the pressure line of FIG. 5 that the pump is on. For example, if the device is consuming 800 watts, tank pressure may be 110 psi or 153 psi. However, if, after running for a short time, the power increases slightly, the pressure may be indicated by the point on the left, or 110 psi. If, however, the power decreases slightly, then the pressure may be indicated by the point on the right, or 153 psi. Thus, since the tank was 30 psi when the pressure switch closed, 30 psi may be subtracted from the current reading to calculate the total pressure. The exact water level in the well may also be determined. Accordingly, the load management and advanced control system may use a graph such as FIG. 5 to determine how many gallons per minute are being pumped. Once the tank pressure comes up to 50 psi, the pressure switch may be turned off. The load management and advanced metering device may detect this and subtract 50 psi from the total pressure and the exact water level may again be determined. The pump may then be shut off. The load management and advanced metering device may then wait until the pressure switch indicates that the tank pressure has dropped back down to 30 psi. In certain embodiments, the gallons being pumped per minute from the pump may be tracked the whole time the pump was running. Thus, the load management and advanced metering system may determine how much water was pumped and may compare the water levels in the well to determine the drawdown from pump operation. When the pump is turned back on and water level in the well is determined, well recovery time may be determined. Accordingly, the teachings of the present disclosure may present solutions for pump and well status tracking operations.

In certain embodiments, well pump depth may be known at a certain time. The load management and advanced metering device may be programmed or set with this initial well depth. Pump operations may be controlled in accordance with the determined water level in the well. For example, the load management and advanced metering device may shut off the pump when the water level drops below a certain level in order to protect the pump from “running dry” and ruining the pump. Power cutoffs may also be defined. For example, the pump may be cut off if the power level gets below around 400 watts. Such a power level may indicate that the pump is un-loaded. In other words, the pump may be shut off if it is operating at a very high pressure or sucking air. As another example, if water in the pipes between the pump and the pressure tank freeze the water-flow may be impaired and/or blocked. This may cause pressure in the pump to rise. In certain embodiments, the load management and advanced metering device may detect this pressure build-up and may shut off the pump. This may prevent the outcome of breaking a fitting pipe due to rising pump pressure.

In certain embodiments, water usage may additionally be measured in order to detect leaks and other usage problems. The water usage levels may be stored and time analysis operations may be conducted on the stored water levels. Leaks and other anomalous water usage trends may be detected. System pressure may drop during a leak event. This may also be detected by the increase in pump power. Thus, several mechanisms for detecting a leak in the water pump system may be presented. Further, specific power usage rules may be employed while the fault condition is experienced. For example, when the load management and advanced metering system detects a leak in the pump system this may trigger a fault operation condition until the leak is fixed. The fault operation may consist of, for example, running the pump for only six minutes every hour through the night. This may have a large impact on energy and water conservation efforts at scale.

In certain embodiments, a pump system may not require contactors or over current protection. For example, the owner of a pump system may install electrodes in the well for measurement of some or all of the above described pump system properties. Thus, by utilizing the load management and advanced metering system described in the present disclosure, installation and monitoring of those monitoring tools may not be required. In certain embodiments, damage caused to pump systems by volatile grid operations may be minimized. For example, some pumps may simulate a three phase inductive motor by utilizing single phase power with an AC run capacitor. To start such motors, a thermal relay connects to a second higher capacitance capacitor. This relay is connected each time the pump is powered on. However, if the relay keeps the starting capacitor connected for even slightly too long, the capacitor may be destroyed and/or damaged and may cause damage, including chemical contamination. If the power grid is coming on and off-line frequently, such as every few seconds, the starting capacitor may not have enough cooling time between restart operations. Thus, the capacitor may self-destruct and the system may be unable to provide water because the pump cannot start. In certain embodiments, the load management and advanced metering device may prevent volatile grid power fluctuations from reaching such loads with sensitive startup operations. Further, the load management and advanced metering device may use another relay to contact integrated capacitors. Thus, the start-up capacitors of the pump may be eliminated. Such a configuration may aid maintenance operations on the pump, because startup capacitors may be inspected at the relay, without removing the pump from the well. Additionally, the load management and advanced metering device may perform selective diagnostics on such a configuration. For example, by connecting one of the three wires to the pump, current flowing through the system can be determined, which permit detection of broken or damaged wires and/or connections, shorted connections, and/or damaged insulation. These diagnostic tests may be shared with the rest of the power system and may be transmitted to a pump technician. Thus, not only may the pump technician no longer need to remove the pump from the well to inspect the startup capacitors, but the technician may also no longer need to leave his/her office to inspect the pump system.

In certain embodiments, the load management and advanced metering device may be configured in accordance with a pump filling an open tank. Such a configuration may be the most common system on large forms and hilly terrain. Currently, such systems may operate until the tank overflows. Such operations may waste a large amount of water and energy. In more advanced systems, level sensors are installed in the tank and wires run from the tank to the pump controls. The pump controls may shut off the contactors based on the detected water levels inside the tank. In accordance with the teachings of the present disclosure, an inexpensive float valve may be embedded in the tank. When the valve begins to close, the pressure rises and the power goes down (e.g., FIG. 5). Accordingly, the load management and advanced metering device may shut off the pump. Water level in the well when the pump is running may be determined using the measured elevation of the tank at a set water level. Full operation of the float valves may not be required, since the valves are merely being used to restrict flow to detect pressure and thus power difference. After a predetermined amount of time, the load management and advanced metering device starts the pump until the float valve closes. If water freezes in the pipe the load management and advanced metering device still shuts off power. Such a configuration may provide advantages in ease of installation and maintenance to other solutions.

While the examples presented in this disclosure may be programmed to re act in a certain manner to certain types of events, nearly any type of application, analysis, model, rule, and fault configuration is applicable to the presented system. For example, various fault configurations for air compressors, refrigerators, heat pumps, and air-conditioners.

In certain embodiments, a shunt load may be applied to load the generator down when energy is not needed. A relay may be configured for such a purpose. For example, some wind generators, such as SOUTHWEST WINDPOWER SKYSTREAM™ and solar micro-inverters are designed to hook directly up to a public power grid. These generators may additionally be connected to a bi-directional AC-DC power converter and supplied directly to local batteries or loads. However, when these generators are not attached to a public grid, the batteries are fully charged, and the running AC loads are not using the generated energy, the load management and advanced metering device may open the relays. When energy is needed by the system again, the load management and advanced metering device may again close the relays.

The teachings of the present disclosure may additionally reduce the total amp service required for a given household. For example, a typical breaker panel for 100 amp service contains lines that total over 100 amps. However, since the individual circuits don't all run at the maximum load at the same time during normal operation, there is no power interruption. However, when the loads add up to approach the service level threshold, the breaker trips cutting out everything. The load management and advanced metering device may automatically disconnect loads as this threshold is approached. Thus, service interruptions may be reduced. Further, since even 50 amp service is probably enough to service the majority of households, the load management and advanced metering device may enable homes to reduce their utility energy consumption by cycling through loads based on prioritized power usage schedules.

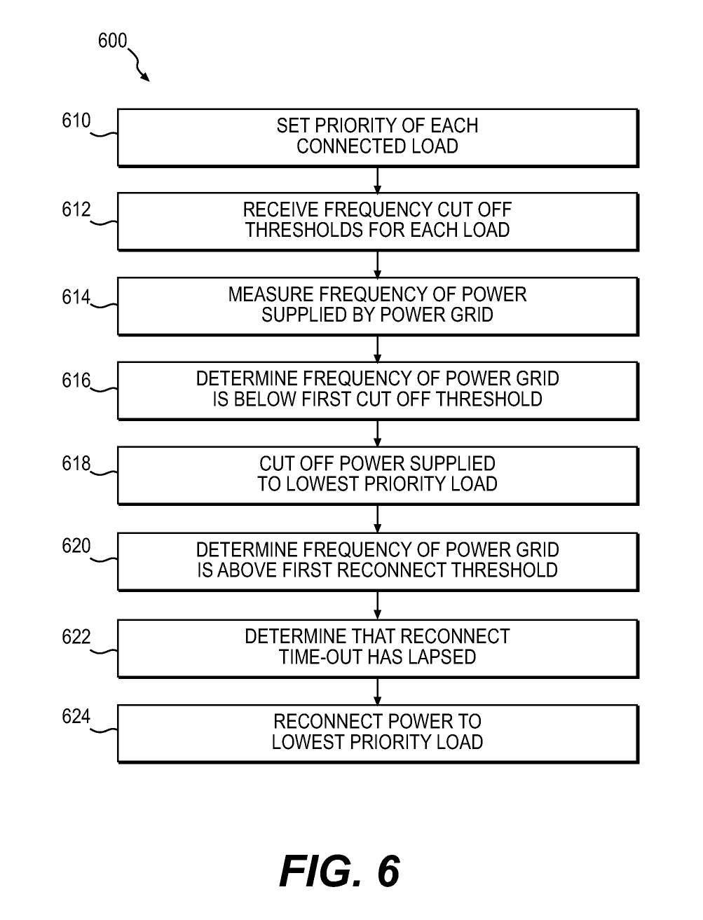

With reference to FIG. 6, a flowchart of a method for load management, metering, and demand response is illustrated in accordance with a non-limiting embodiment of the present disclosure. At step 610, a priority for each load connected to a load management and advanced metering device is set. For example, a first load corresponding to communications devices, such as the internet modem, computer, and/or telephone may be set with a high priority while lower priority devices with flexible power cycles such as, for example, a refrigerator or HVAC system may be set with lower priorities.

At step 612, frequency cut off thresholds are received for each connected load. For example, the load management and advanced metering device has an interface through which it receives programming and instructions. A user may program a frequency cut off threshold for each port, switch, and/or load connected to or available to the device. The frequency cut off thresholds may each be a predetermined threshold that governs the measured main power line frequency at which the corresponding load will be disconnected. However, other special rules and intervening instructions may apply before any individual load is disconnected.

At step 614, the frequency of the power supplied by a public utility power grid is measured at a main power line. For example, an electrode or other measurement device may be connected to the main power line entering a, for example, home, apartment, office, or the like. In this example, the measurement device may be physically remote from the load management and advanced metering device, but may still be connected via a network. As another example, the main power lines may connect directly to the load management and advanced metering device and route measurements directly to the device.

At step 616, the load management and advanced metering device determines whether the frequency of the power grid is below a first cut off threshold. For example, the first cut off threshold may be a highest cut off threshold. Each cut off threshold may be tested against the measured frequency of the power grid.

At step 618, the load management and advanced metering device operates a respective switch for the lowest priority load. For example, when the load management and advanced metering device detects a low power frequency in the main power line, the device may determine the lowest priority load based on the received priorities. The load management and advanced metering device may disconnect, in the above example, the refrigerator or HVAC system. Alternatively, advanced metering device may cycle through and disconnect lower priority loads, and in the above example, selectively disconnect and reconnect the refrigerator and HVAC system, as well as other systems, in sequence over a predetermined duty cycle so that no lapse in service is perceived for a particular load associated with a flexible power cycle.

At step 620 a frequency of the power grid is again determined and tested against a reconnect threshold. For example, the disconnected load may be programmed with a reconnect frequency threshold.

As another example outside the scope of FIG. 6, loads may be connected when the power grid frequency reaches or exceeds a certain level. This level may be at or above, for example, 60 Hz. Connecting loads at or above this frequency may also help stabilize a power grid.

Returning to FIG. 6, at step 622 the load management and advanced metering device determines whether the reconnect time-out has lapsed. The reconnect time-out may be a programmable setting that ensures that loads with fragile components are not damaged during load disconnection and reconnection operations. The load management and advanced metering device may thus reconnect disconnected loads once power grid frequency has stabilized and once a certain reconnect threshold is reached. At step 624, power is reconnected to the lowest priority load.

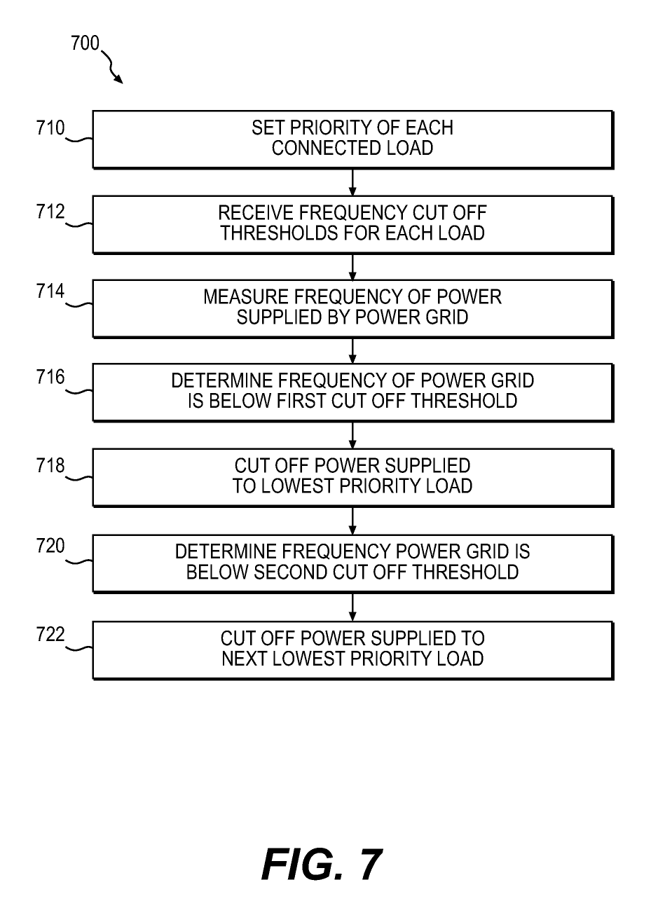

With reference to FIG. 7, another flowchart of a method for load management, metering, and demand response is illustrated in accordance with a non-limiting embodiment of the present disclosure. Steps 710-718 roughly mirror steps 610-618 of FIG. 6. At step 720, the frequency of the power grid is again determined. If the frequency of the power grid is below a second cut off threshold, the second priority load may be disconnected from the power supply line. This illustrates the progressive nature of the load management and advanced metering device. For example, third priority loads, fourth priority loads, and so on may be disconnected until grid stability is reached.

However, the cascaded disconnection of relatively small loads at the micro level, as illustrated in FIG. 7, may have a much more powerful impact on grid stability control in the aggregate. For example, if one out of every 10 homes installed a device in accordance with the teachings of the present disclosure, the aggregate effect of each home shutting off a small low-priority load may translate into reduced grid instability and reduced brownouts. Additionally, fewer high priority loads may be disconnected because many homes may responsively and timely disconnecting low priority loads.

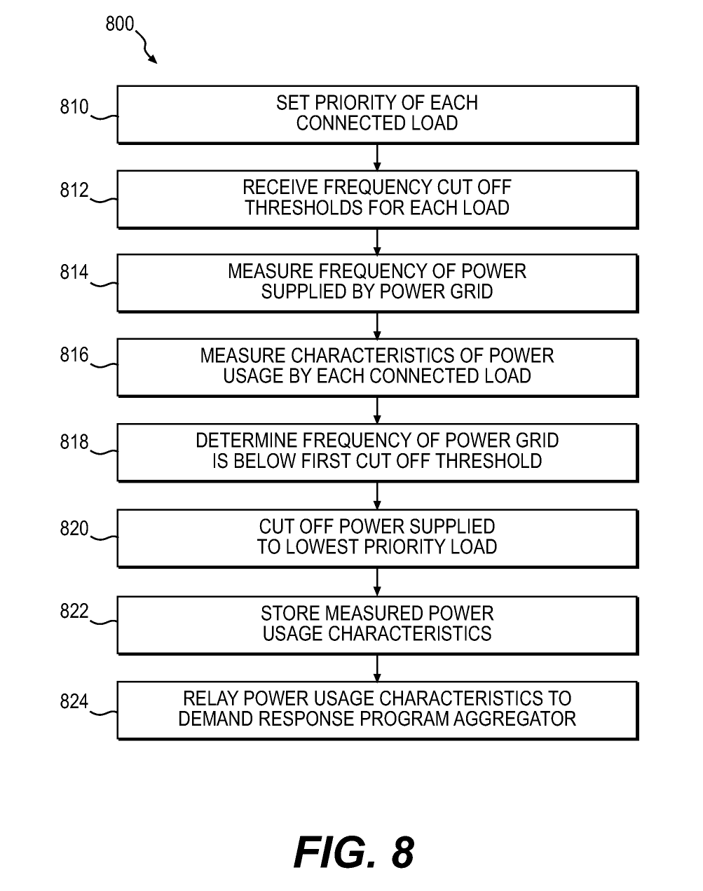

With reference to FIG. 8, yet another flowchart of a method for load management, metering, and demand response is illustrated in accordance with a non-limiting embodiment of the present disclosure. Priorities of each load are set and frequency thresholds are received at steps 810-812. At step 814, power grid frequency is measured. At step 816, characteristics of power usage of each connected load are measured by the load management and advanced metering device. For example, electrodes may be connected to each switch and may relay power usage characteristics of each connected load to the load management and advanced metering device. At steps 818-820, a frequency threshold is reached in the power grid and the lowest priority load is disconnected. At step 822, information regarding the disconnection event is stored in the form of measured power usage characteristics. For example, in addition to metering capabilities, the load management and advanced metering device may store information regarding demand response activities. At step 824, this information may be relayed to a demand response program aggregation module. Thus, installation of the devices described in accordance with the teachings of the present disclosure may enable participation in demand response programs, and may allow payment for demand response services conducted automatically by a load management and advanced metering device.

The teachings of the present disclosure may further enable recreational vehicles boats and other moveable power consumers to maximize power service available by switching on and off loads accordance to the available power.

In certain embodiments, grid current limiting features may also be implemented by modifying grid frequency. For example load management devices may communicate with each other via grid frequency variations in the grid, such as super slow FM communications.

While the disclosure has been described in connection with preferred embodiments and examples, it will be understood by those skilled in the art that other variations and modifications of the preferred embodiments described above may be made without departing from the scope of the disclosure. Other embodiments will be apparent to those skilled in the art from a consideration of the specification or practice of the present disclosure that is described herein. It is intended that the specification is considered as exemplary only, with the true scope and spirit of the present disclosure being indicated by the following claims.

What is claimed is:

1. A load management system comprising:
a plurality of switches comprising:
a first switch connecting a first load in a plurality of loads to a power supply line, wherein the power supply line is connected to a public utility power grid; and
a second switch connecting a second load in the plurality of loads to the power supply line;
a power measurement device configured to measure a power grid frequency at the power supply line; and
a load control module configured to operate the second switch to disconnect the second load from the power supply line when the power grid frequency is lower than a predetermined frequency threshold.

2. The load management system of claim 1, wherein the plurality of switches further comprises a third switch connecting a third load in the plurality of loads to the power supply line, wherein the load control module is further configured to cycle between disconnecting the second load and the third load when the power grid frequency is lower than the predetermined frequency threshold, based on an associated priority for each of the plurality of loads.

3. The load management system of claim 1, wherein the load control module is further configured to operate the first switch to disconnect the first load from the power supply line when the power grid frequency is lower than a second predetermined frequency threshold, wherein the second predetermined frequency threshold is less than or equal to the predetermined frequency threshold.

4. The load management system of claim 1, wherein the load control module is further configured to:
receive a respective new frequency threshold for each of the plurality of loads; and
disconnect each of the plurality of loads from the power supply line when the power supply line frequency is lower than each respective new frequency threshold.

5. The load management system of claim 1, wherein the load control module is further configured to transmit information indicative of operation of each of the plurality of switches by the load control module to a demand response data aggregation module.

6. The load management system of claim 1, further comprising:
a second power measurement device configured to measure power usage characteristics of the first load.

7. The load management system of claim 6, wherein the load control module is further configured to transmit the measured power usage characteristics of the first load to a power data aggregation module.

8. The load management system of claim 1, further comprising:
a pressure measurement device configured to measure tank pressure of a fluid tank, wherein the first load comprises a pump, and wherein the load control module is further configured to operate the first switch to disconnect the pump from the power supply line based on the measured tank pressure.

9. The load management system of claim 8, wherein the second load comprises a starting circuit of the pump, wherein the pump is a single phase inductive motor pump, and wherein the load control module is further configured to operate the second switch to disconnect the starting circuit.

10. The load management system of claim 1, wherein the load control module is further configured to determine a dangerous power condition in the power supply line;
wherein the load control module is further configured to operate the first switch to disconnect the first load from the power supply line when the dangerous power condition is determined; and
wherein the dangerous power condition is based on an amount of power grid volatility measured at the power supply line.

11. The load management system of claim 1, wherein the load control module is further configured to operate the second switch to connect the second load to the power supply line when the power grid frequency is greater than a second predetermined frequency threshold.

12. The load management system of claim 11, wherein the second predetermined frequency threshold is about 60 Hz.

13. The load management system of claim 1, further comprising:
a generator for generating power; and
a power module configured to transmit the generated power from the generator to the first load, wherein the load control module is further configured to receive power module information from the power module, and wherein the load control module is further configured to operate the first switch to disconnect the first load from the power supply line based on the power module information.

14. The load management system of claim 1, further comprising:
a display configured to display:
power usage information for the first load; and
the measured power grid frequency at the power supply line.

15. A load management method, comprising:
connecting a first load in a plurality of loads to a power supply line connected to a public utility power grid using a first switch in a plurality of switches;
connecting a second load in the plurality of loads to the power supply line using a second switch in the plurality of switches;
measuring a power grid frequency at the power supply line;
determining that the power grid frequency is lower than a predetermined frequency threshold; and
in response to determining that the power grid frequency is lower than a predetermined frequency threshold, operating the second switch to disconnect the second load from the power supply line.

16. The load management method of claim 15, further comprising:
cycling between disconnecting the second load and a third load connected to the power supply line when the power grid frequency is lower than the predetermined frequency threshold, based on an associated priority for each of the first load and the second load.

17. The load management method of claim 15, further comprising:
determining that the power grid frequency is lower than a second predetermined frequency threshold; and
in response to determining that the power grid frequency is lower than the second predetermined frequency threshold, operating the first switch to disconnect the first load from the power supply line.

18. The load management method of claim 15, further comprising:
receiving a respective new frequency threshold for each of the plurality of loads; and
disconnecting each of the plurality of loads from the power supply line when the power supply line frequency is lower than each respective new frequency threshold.

19. The load management method of claim 15, further comprising:
transmitting information indicative of operation of each of the plurality of switches by the load control module to a demand response data aggregation module.

20. The load management method of claim 15, further comprising:
measuring power usage characteristics of the first load; and
transmitting the measured power usage characteristics to a power data aggregation module.
